(19) United States
(12) Patent Application Publication
(10) Pub. No.: US 2026/0072728 A1
(43) Pub. Date: Mar. 12, 2026

(54) INTERRUPT CONTROL DEVICE, INTERRUPT CONTROL METHOD, AND NETWORK INTEGRATED CIRCUIT

(71) Applicant: Realtek Semiconductor Corporation, Hsinchu (TW)

(72) Inventors: MIN-YU TSENG, Hsinchu (TW); Chia-Hung Lin, Hsinchu (TW); Hau-Yuan Peng, Hsinchu (TW); Tsung-Han Tsai, Hsinchu (TW)

(21) Appl. No.: 19/316,730

(22) Filed: Sep. 2, 2025

(30) Foreign Application Priority Data
Sep. 10, 2024 (TW) 113134315

(51) Int. Cl. G06F 9/48; G06F 9/30

(52) U.S. Cl. CPC G06F 9/4831; G06F 9/30101

(57) ABSTRACT

An interrupt control device includes an interrupt request register and an interrupt mask register. The interrupt request register is configured to record a first interrupt event during an interrupt enable period, and the interrupt control device outputs the first interrupt event during the interrupt enable period. The interrupt mask register is configured to switch the interrupt enable period to an interrupt disable period according to an interrupt acknowledge signal, and the interrupt request register records a second interrupt event during the interrupt disable period. The interrupt mask register is configured to switch the interrupt disable period to the interrupt enable period according to an end of interrupt signal, and the interrupt control device outputs the second interrupt event during the interrupt enable period.

### BACKGROUND OF THE INVENTION

### Field of the Invention

The present disclosure relates to an interrupt control device, an interrupt control method, and a network integrated circuit, especially to an interrupt control device, an interrupt control method, and a network integrated circuit capable of recording additional interrupt events during an interrupt disable period and outputting these additional interrupt events during an interrupt enable period.

### Description of Related Art

A network integrated circuit (NIC) receives packets from a physical layer, and stores the packets in the buffer of the network integrated circuit. Subsequently, the network integrated circuit transmits the packets to a system end and generates interrupt events to notify the system end accordingly.

After the system end receives the interrupt signal, the system end schedules packet processing tasks into a scheduling queue of an operating system. Besides, the system end issues an interrupt acknowledge signal to the network integrated circuit to disable interrupts. In this situation, if the network integrated circuit receives additional packets, it is unable to generate additional interrupt signals to notify the system end, such that the additional packets miss the opportunity to notify the system end for processing.

### SUMMARY OF THE INVENTION

In some aspects, an object of the present disclosure is to, but not limited to, provides an interrupt control device, an interrupt control method, and a network integrated circuit that makes an improvement to the prior art.

An embodiment of an interrupt control device of the present disclosure includes an interrupt request register and an interrupt mask register. The interrupt request register is configured to record a first interrupt event during an interrupt enable period, and the interrupt control device outputs the first interrupt event during the interrupt enable period. The interrupt mask register is configured to switch the interrupt enable period to an interrupt disable period according to an interrupt acknowledge signal, and the interrupt request register records a second interrupt event during the interrupt disable period. The interrupt mask register switches the interrupt disable period to the interrupt enable period according to an interrupt end signal, and the interrupt control device outputs the second interrupt event during the interrupt enable period.

An embodiment of an interrupt control method of the present disclosure is applied in an interrupt control device. The interrupt control device includes an interrupt request register and an interrupt mask register. The interrupt control method includes: recording a first interrupt event by the interrupt request register during an interrupt enable period, and outputting the first interrupt event by the interrupt control device during the interrupt enable period; switching the interrupt enable period to an interrupt disable period by the interrupt mask register according to an interrupt acknowledge signal, and recording a second interrupt event by the interrupt request register during the interrupt disable period; and switching the interrupt disable period to the interrupt enable period by the interrupt mask register according to an interrupt end signal, and outputting the second interrupt event by the interrupt control device during the interrupt enable period.

An embodiment of a network integrated circuit of the present disclosure includes an interrupt control device. The interrupt control device includes an interrupt request register and an interrupt mask register. The interrupt request register is configured to record a first interrupt event during an interrupt enable period, and the interrupt control device outputs the first interrupt event during the interrupt enable period. The interrupt mask register is configured to switch the interrupt enable period to an interrupt disable period according to an interrupt acknowledge signal, and the interrupt request register records a second interrupt event during the interrupt disable period. The interrupt mask register switches the interrupt disable period to the interrupt enable period according to an interrupt end signal, and the interrupt control device outputs the second interrupt event during the interrupt enable period.

Technical features of some embodiments of the present disclosure make an improvement to the prior art. The interrupt control device, the interrupt control method, and the network integrated circuit of the present disclosure are capable of recording additional interrupt events during the interrupt disable period and outputting these additional interrupt events during the interrupt enable period, thereby avoiding the problem that additional interrupt events cannot be generated to notify the system end after the interrupt is disabled, resulting in the additional packets missing the opportunity to notify the system end for processing.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a network integrated circuit and a system end of the present disclosure.

FIG. 2 shows an embodiment of a flow diagram of an interrupt control method of the present disclosure.

FIG. 3 shows an embodiment of a communication flow of the present disclosure.

FIG. 4 shows an embodiment of a communication flow of the present disclosure.

FIG. 5 shows an embodiment of an operation diagram of an interrupt control device of the present disclosure.

FIG. 6 shows an embodiment of an operation diagram of an interrupt control device of the present disclosure.

FIG. 7 shows an embodiment of an operation diagram of an interrupt control device of the present disclosure.

FIG. 8 shows an embodiment of an operation diagram of an interrupt control device of the present disclosure.

FIG. 9 shows an embodiment of an operation diagram of an interrupt control device of the present disclosure.

FIG. 10 shows an embodiment of an operation diagram of an interrupt control device of the present disclosure.

FIG. 11 shows an embodiment of an operation diagram of an interrupt control device of the present disclosure.

FIG. 12 shows an embodiment of an operation diagram of an interrupt control device of the present disclosure.

FIG. 13 shows an embodiment of an operation diagram of an interrupt control device of the present disclosure.

FIG. 14 shows an embodiment of an operation diagram of an interrupt control device of the present disclosure.

### DETAILED DESCRIPTION OF THE PREFERRED EMBODIMENTS

To address the problem that, during the interrupt disable period, the network integrated circuit (NIC) cannot transmit interrupt events to the system end, resulting in additional packets missing the opportunity to notify the system end for processing, the present disclosure provides an interrupt control device, an interrupt control method, and a network integrated circuit, which will be explained in detail as shown below.

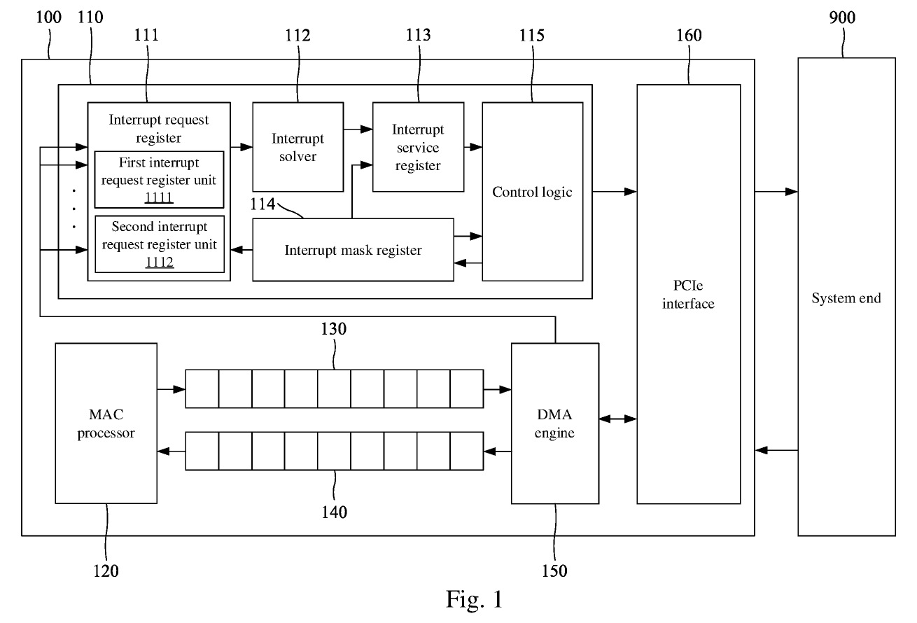

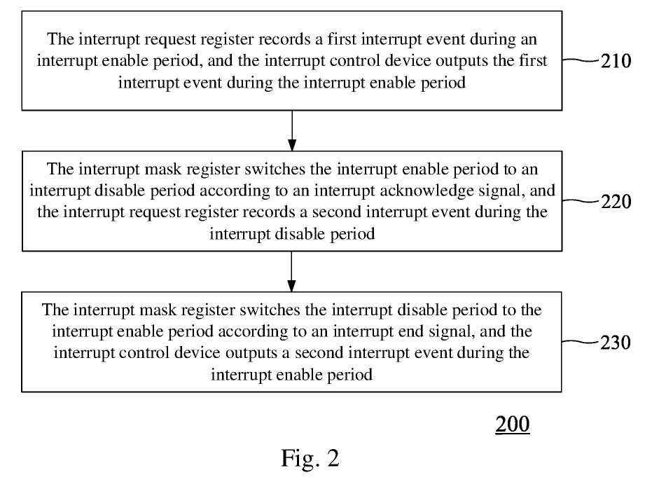

FIG. 1 shows an embodiment of a network integrated circuit 100 and a system end 900 of the present disclosure. As shown in the figure, the network integrated circuit 100 includes an interrupt control device 110, a media access control (MAC) processor 120, a receive buffer 130, a transmit buffer 140, a direct memory access (DMA) engine 150, and a peripheral component interconnect express (PCIe) interface 160. The interrupt control device 110 includes an interrupt request register 111, an interrupt solver 112, an interrupt service register 113, an interrupt mask register 114, and a control logic 115. To facilitate the understanding of the operation of the network integrated circuit 100, please also refer to FIG. 2, which is a flow diagram of an interrupt control method 200 of the present disclosure.

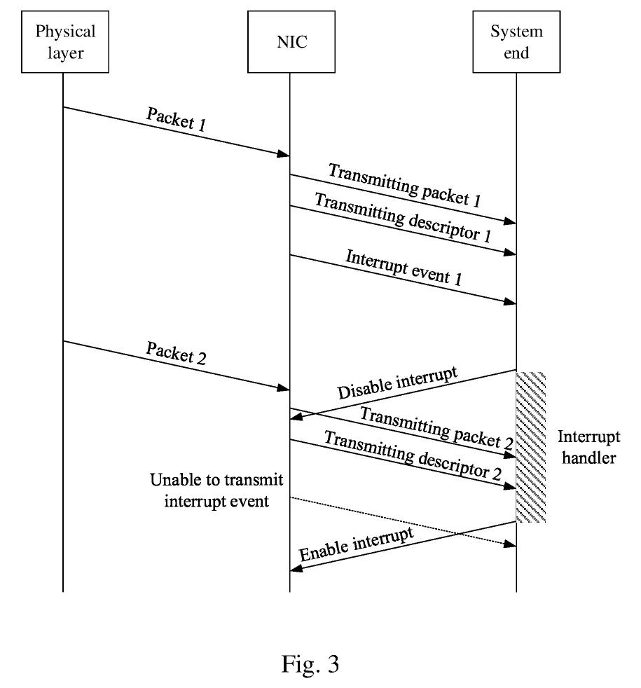

Before describing the interrupt control method 200, the overall communication flow will be introduced first. Please also refer to FIG. 1 and FIG. 3. Firstly, the network integrated circuit 100 receives a packet 1 from the physical layer. Subsequently, the network integrated circuit 100 transmits the packet 1 and a corresponding descriptor 1 to the system end 900. At the same time, the network integrated circuit 100 transmits an interrupt event (e.g., interrupt) 1 to notify the system end 900. After the system end 900 receives the interrupt event 1, the system end 900 activates an interrupt handler to schedule the packet processing task of the packet 1 into the scheduling queue of the operating system. Meanwhile, the system end 900 transmits a disable interrupt signal to the network integrated circuit 100 to disable the interrupt. After the interrupt handler is completed, the system end 900 transmits an interrupt end signal (e.g., End of Interrupt (EOI)) to the network integrated circuit 100 to enable the interrupt. During the interrupt disable period described above, the network integrated circuit 100 may be unable to transmit the interrupt events to the system end 900, which may result in the additional packets (e.g., packet 2) missing the opportunity to notify the system end 900 for processing.

To address the above-mentioned issue, please refer to FIG. 2. In step 210, the interrupt request register 111 records a first interrupt event during an interrupt enable period, and the interrupt control device 110 outputs the first interrupt event during the interrupt enable period. For example, referring to FIG. 1, when the media access control (MAC) processor 120 of the network integrated circuit 100 receives a packet from a physical layer (not shown), the packet is temporarily stored in the receive buffer 130, then the direct memory access (DMA) engine 150 transmits the packet to the system end 900 through the peripheral component interconnect express (PCIe) interface 160, and a corresponding interrupt event is generated. Subsequently, the interrupt request register 111 of the interrupt control device 110 records the interrupt event during the enable interrupt period. If the interrupt solver 112 allows the transmission of the interrupt event, the interrupt control device 110 outputs the interrupt event to the system end 900 via the peripheral component interconnect express interface 160 during the interrupt enable period.

In step 220, the interrupt mask register 114 switches the interrupt enable period to an interrupt disable period according to an interrupt acknowledge signal, and the interrupt request register 111 records a second interrupt event during the interrupt disable period. For example, after the system end 900 receives the above-mentioned interrupt event, the system end 900 transmits a disable interrupt signal to the network integrated circuit 100 to disable the interrupt. On the other hand, the interrupt mask register 114 of the network integrated circuit 100 switches the interrupt enable period to the interrupt disable period according to the interrupt acknowledge signal. At this time, the interrupt request register 111 can record additional interrupt events during the interrupt disable period.

In step 230, the interrupt mask register 114 switches the interrupt disable period to the interrupt enable period according to an interrupt end signal, and the interrupt control device 110 outputs the second interrupt event during the interrupt enable period. For example, after the interrupt handler is completed, the system end 900 transmits an interrupt end signal (e.g., End of Interrupt (EOI)) to the network integrated circuit 100 to enable the interrupt. Specifically, the interrupt mask register 114 switches the interrupt disable period to the interrupt enable period according to the interrupt end signal. Subsequently, if the interrupt solver 112 allows transmission of the additional interrupt events in the interrupt disable period, the interrupt control device 110 outputs the additional interrupt events to the system end 900 during the interrupt enable period.

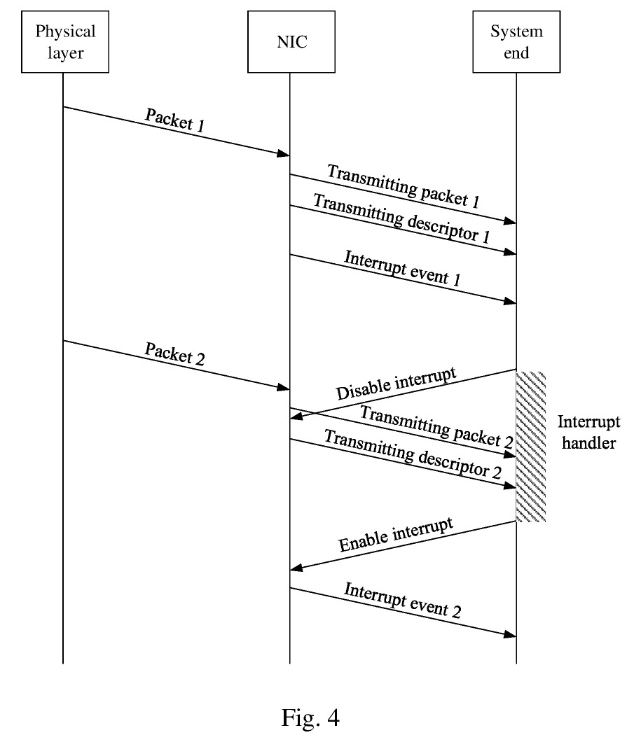

Referring to both FIG. 1 and FIG. 4, since the network integrated circuit 100 of the present disclosure can record additional interrupt events through the interrupt request register 111 during the interrupt disable period, after the interrupt mask register 114 switches to the interrupt enable period according to the interrupt end signal, the interrupt control device 110 can output the interrupt event 2 to the system end 900 according to the record of the interrupt request register 111 during the interrupt enable period. In this way, the present disclosure can avoid the problem that the network integrated circuit 100 in FIG. 3 cannot transmit the interrupt event to the system end 900, resulting in the packet 2 missing the opportunity to notify the system end 900 for processing.

In some embodiments, the interrupt request register 111 records the first interrupt event as a first interrupt record during the interrupt enable period, and the interrupt control device 110 outputs the first interrupt event according to the first interrupt record during the interrupt enable period. For example, after the media access control processor 120 of the network integrated circuit 100 receives a packet transmitted from the physical layer (not shown), the packet is temporarily stored in the receive buffer 130, then the direct memory access engine 150 transmits the packet to the system end 900 through the peripheral component interconnect express interface 160, and a corresponding interrupt event is generated. Subsequently, the interrupt request register 111 of the interrupt control device 110 records the interrupt event as an interrupt record during the interrupt enable period. If the interrupt solver 112 allows transmission of the interrupt event, the interrupt control device 110 outputs the interrupt event to the system end 900 according to the interrupt record through the peripheral component interconnect express interface 160 during the interrupt enable period.

In some embodiments, the interrupt mask register 114 receives an interrupt acknowledge signal during the interrupt enable period, and switches the interrupt enable period to the interrupt disable period according to the interrupt acknowledge signal. The interrupt request register 111 records the second interrupt event as a second interrupt record during the interrupt disable period. The interrupt mask register 114 receives an interrupt end signal during the interrupt disable period, and switches the interrupt disable period to the interrupt enable period according to the interrupt end signal. The interrupt control device 110 outputs the second interrupt event according to the second interrupt record during the interrupt enable period. For example, after the system end 900 receives the above-mentioned interrupt event, the system end 900 transmits a disable interrupt signal to the network integrated circuit 100 to disable interrupts. On the other hand, the interrupt mask register 114 of the network integrated circuit 100 receives the interrupt acknowledge signal, and switches the interrupt enable period to the interrupt disable period according to the interrupt acknowledge signal. At this time, the interrupt request register 111 records the additional interrupt event as additional interrupt records during the interrupt disable period. After the interrupt handler is completed, the system end 900 transmits an interrupt end signal to the network integrated circuit 100 to enable interrupts. Specifically, the interrupt mask register 114 receives the interrupt end signal, and switches the interrupt disable period to the interrupt enable period according to the interrupt end signal. Subsequently, if the interrupt solver 112 allows transmission of the additional interrupt events in the interrupt disable period, the interrupt control device 110 outputs the additional interrupt events to the system end 900 according to the additional interrupt records during the interrupt enable period.

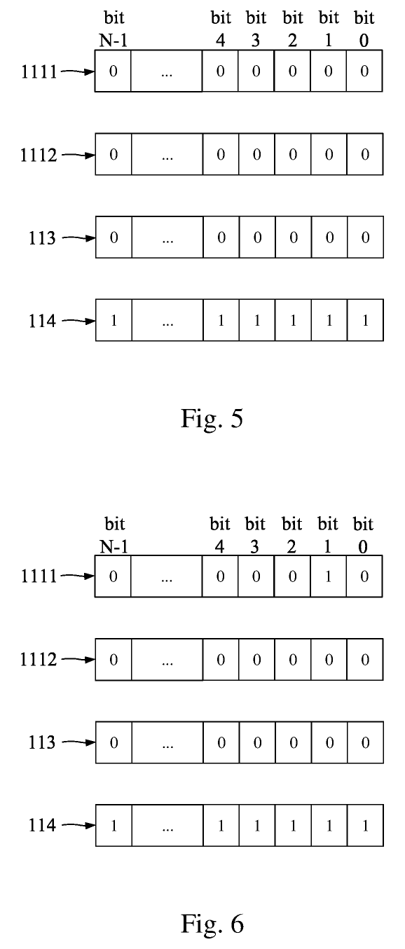

In some embodiments, the interrupt request register 111 includes a first interrupt request register unit 1111, and the first interrupt request register unit 1111 is configured to record the first interrupt event as a first interrupt record during the interrupt enable period. For example, referring to FIG. 1 and FIG. 5, the initial state of the first interrupt request register unit 1111 is shown in FIG. 5. Referring to FIG. 1 and FIG. 6, when the first interrupt event occurs, the first interrupt request register unit 1111 sets the interrupt record bit [1] to 1 according to the interrupt event during the interrupt enable period.

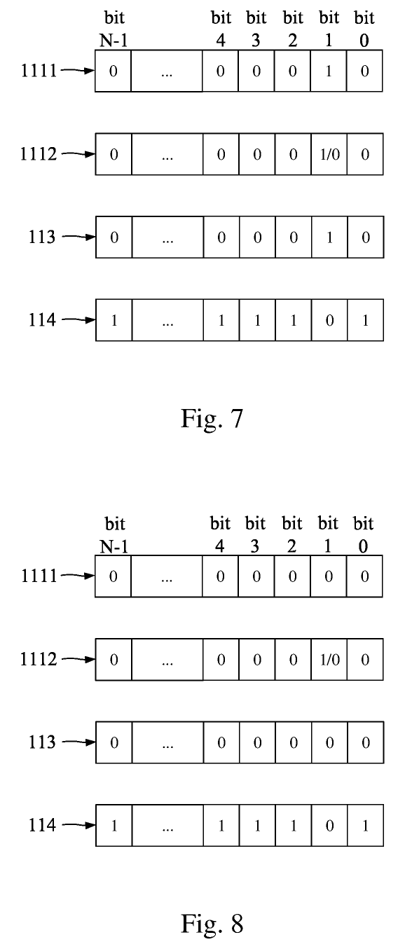

In some embodiments, an interrupt service register 113 of the interrupt control device 110 is configured to record an interrupt service record according to the first interrupt record during the interrupt enable period, and the interrupt control device 110 outputs the first interrupt event according to the interrupt service record during the interrupt enable period. For example, referring to FIG. 1 and FIG. 7, if the interrupt solver 112 allows the transmission of the interrupt event, the interrupt service register 113 sets the interrupt service record bit [1] to 1 according to the interrupt record during the interrupt enable period. When the interrupt service record bit [1] changes from 0 to 1, the control logic 115 of the interrupt control device 110 outputs the interrupt event to the system end 900 during the interrupt enable period, and transmits an interrupt acknowledge signal to the interrupt mask register 114.

In some embodiments, the interrupt mask register 114 receives the interrupt acknowledge signal during the interrupt enable period, and switches the interrupt enable period to the interrupt disable period according to the interrupt acknowledge signal. The interrupt request register 111 further includes a second interrupt request register unit 1112, and the second interrupt request register unit 1112 is configured to record a second interrupt event as a second interrupt record during the interrupt disable period. For example, referring to FIG. 1 and FIG. 7, the interrupt mask register 114 receives the interrupt acknowledge signal during the interrupt enable period, switches the interrupt enable period to the interrupt disable period according to the interrupt acknowledge signal, and sets the interrupt mask record bit [1] to 0. At this time, the second interrupt request register unit 1112 of the interrupt request register 111 can record additional interrupt events during the interrupt disable period. If additional interrupt events occur during the interrupt disable period, the second interrupt request register unit 1112 sets the interrupt record bit [1] to 1 according to the additional interrupt events. Moreover, if no additional interrupt event occurs during the interrupt disable period, the interrupt record bit [1] of the second interrupt request register unit 1112 remains 0. Therefore, the interrupt record bit [1] of the second interrupt request register unit 1112 is represented as 1/0.

In some embodiments, the interrupt mask register 114 receives the interrupt end signal during the interrupt disable period, switches the interrupt disable period to the interrupt enable period according to the interrupt end signal, and replaces the first interrupt record of the first interrupt request register unit 1111 with the second interrupt record of the second interrupt request register unit 1112. The interrupt control device 110 outputs the second interrupt event according to the second interrupt record of the first interrupt request register unit 1111 during the interrupt enable period. For example, referring to FIG. 1 and FIG. 8, after the interrupt handler is completed, the system end 900 transmits an interrupt end signal to the network integrated circuit 100. The first interrupt request register unit 1111 clears the interrupt record bit [1] to 0 according to the interrupt end signal, and the interrupt service register 113 clears the interrupt service record bit [1] to 0 according to the interrupt end signal.

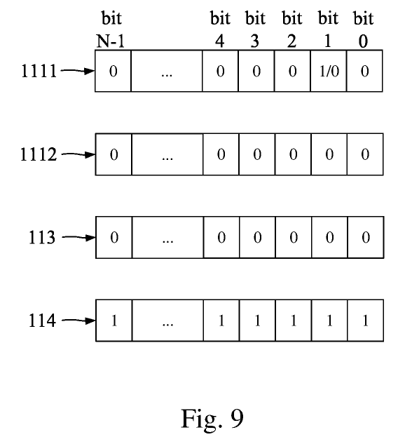

Referring to FIG. 1 and FIG. 9, the interrupt mask register 114 receives the interrupt end signal during the interrupt disable period, switches the interrupt disable period to the interrupt enable period according to the interrupt end signal, and sets the interrupt mask record bit [1] to 1. Subsequently, the interrupt record bit [1] of the first interrupt request register unit 1111 is replaced with the interrupt record bit [1] of the second interrupt request register unit 1112, and the interrupt record bit [1] of the second interrupt request register unit 1112 is cleared to 0. Assuming that the interrupt record bit [1] of the second interrupt request register unit 1112 is 1, the interrupt record bit [1] of the first interrupt request register unit 1111 will be replaced with 1. Besides, assuming that the interrupt record bit [1] of the second interrupt request register unit 1112 is 0, the interrupt record bit [1] of the first interrupt request register unit 1111 will be replaced with 0. Therefore, the interrupt record bit [1] of the first interrupt request register unit 1111 is represented by 1/0. Subsequently, the interrupt control device 110 outputs the interrupt event to the system end 900 according to the interrupt record bit [1] of the first interrupt request register unit 1111 during the interrupt enable period.

In some embodiments, the first interrupt event includes N first interrupt events, wherein N first bits of the first interrupt request register unit are configured to record the N first interrupt events as N first interrupt records, where N is a positive integer. The interrupt control device 110 outputs one of the N first interrupt events to one of the N interrupt vectors of the system end 900 according to one of the N first interrupt records during the interrupt enable period. In some embodiments, the second interrupt event includes N second interrupt events, wherein N second bits of the second interrupt request register unit are configured to record the N second interrupt events as N second interrupt records. The N first interrupt records of the N first bits are replaced with the N second interrupt records of the N second bits, and the interrupt control device outputs one of the N second interrupt events to one of the N interrupt vectors of the system end according to one of the N second interrupt records of the N first bits during the interrupt enable period. For example, assuming that there are N interrupt events inside the network integrated circuit 100, and each of the N interrupt events inside the network integrated circuit 100 can be one-to-one mapped to an interrupt vector of the system end 900, the first interrupt request register unit 1111, the second interrupt request register unit 1112, the interrupt service register 113, and the interrupt mask register 114 inside the network integrated circuit 100 can each be configured with N bits (e.g., bit[0] to bit[N-1]) to record the N interrupt events. The interrupt control device 110 can output the N interrupt events to the corresponding N interrupt vectors of the system end 900 during the interrupt enable period.

In some embodiments, the first interrupt event includes N first interrupt events, wherein N first bits of the first interrupt request register unit 1111 are configured to record the N first interrupt events as N first interrupt records, wherein the N first interrupt records are divided into M groups of first interrupt records, wherein N and M are positive integers, and N is greater than M. The interrupt control device 110 outputs one of the M first interrupt events to one of the M interrupt vectors of the system end 900 according to one of the M groups of first interrupt records during the interrupt enable period. In some embodiments, the second interrupt event includes N second interrupt events, wherein N second bits of the second interrupt request register unit are configured to record the N second interrupt events as N second interrupt records, wherein the N second interrupt records are divided into M groups of second interrupt records. The M groups of first interrupt records of the N first bits are replaced with the M groups of second interrupt records of the N second bits, and the interrupt control device 110 outputs one of the M second interrupt events to one of the M interrupt vectors of the system end 900 according to one of the M groups of second interrupt records of the N first bits during the interrupt enable period. For example, assuming that there are N interrupt events inside the network integrated circuit 100, but not every interrupt event among the N interrupt events inside the network integrated circuit 100 can be one-to-one mapped to an interrupt vector of the system end 900. At this time, it is necessary to configure according to the number of interrupt vectors. Assuming that the number of interrupt vectors is M, the N interrupt events can be divided into M interrupt event groups, so that the M interrupt event groups of the network integrated circuit 100 can correspond to the M interrupt vectors of the system end 900.

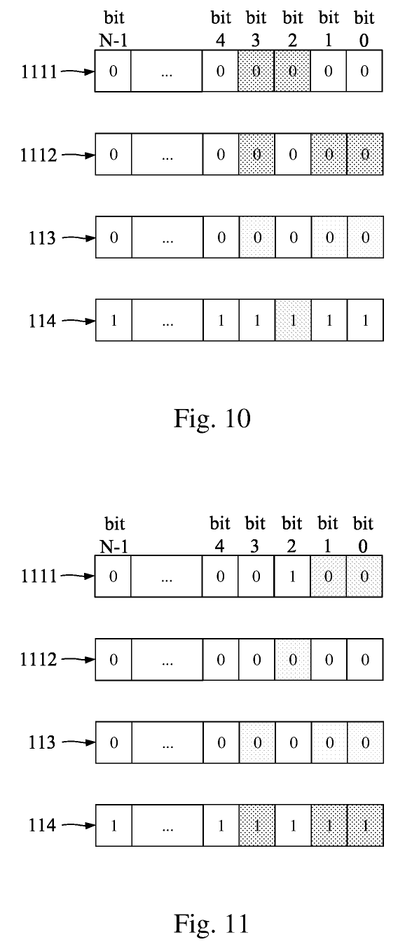

Specifically, referring to FIG. 10 to FIG. 14, the first interrupt request register unit 1111 and the second interrupt request register unit 1112 inside the network integrated circuit 100 can group the record bit [0]~bit [3] of the interrupt events into the same interrupt event record group (e.g., the first interrupt event record group), so as to map the same interrupt event record group to the same interrupt vector (e.g., the first interrupt vector) of the system end 900. Similarly, the first interrupt request register unit 1111 and the second interrupt request register unit 1112 inside the network integrated circuit 100 can further group the record bit [4]~ bit [7] of the interrupt events into the same interrupt event record group (e.g., the second interrupt event record group), so as to map the same interrupt event record group to the same interrupt vector (e.g., the second interrupt vector) of the system end 900. In addition, the relevant record bit [0]~bit [3] of the interrupt service register 113 and the interrupt mask register 114 can also be grouped into the same relevant record group, so as to map the same relevant record group to the same interrupt vector of the system end 900.

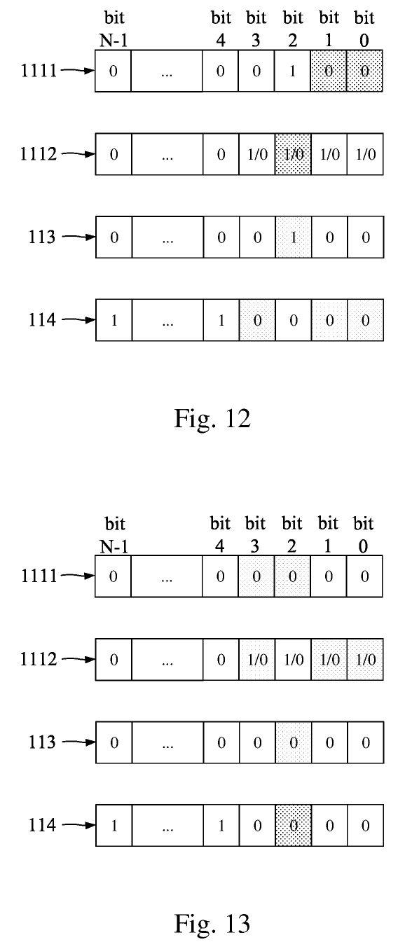

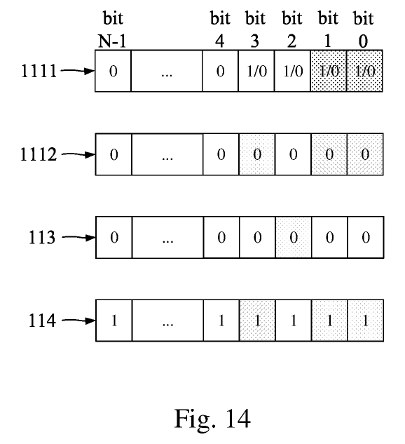

Referring to FIG. 10 to FIG. 14, the related embodiments are described as follows. The embodiment of FIG. 10 is similar to the embodiment of FIG. 5, both illustrating the initial state. The embodiment of FIG. 11 is similar to the embodiment of FIG. 6, where the first interrupt request register unit 1111 sets the interrupt record bit [2] to 1 according to the interrupt event during the interrupt enable period. The embodiment of FIG. 12 is similar to the embodiment of FIG. 7, where the interrupt service register 113 sets the interrupt service record bit [2] to 1 according to the interrupt record during the interrupt enable period. The interrupt mask register 114 receives the interrupt acknowledge signal during the interrupt enable period, switches the interrupt enable period to the interrupt disable period according to the interrupt acknowledge signal, and sets the interrupt mask record bit [0]~bit [3] to 0. At this time, the second interrupt request register unit 1112 of the interrupt request register 111 can record additional interrupt events as the interrupt record bit [0]~bit [3] during the interrupt disable period. The embodiment of FIG. 13 is similar to the embodiment of FIG. 8, where the first interrupt request register unit 1111 clears the interrupt record bit [2] to 0 according to the interrupt end signal, and the interrupt service register 113 clears the interrupt service record bit [2] to 0 according to the interrupt end signal. The embodiment of FIG. 14 is similar to the embodiment of FIG. 9, where the interrupt mask register 114 receives the interrupt end signal during the interrupt disable period, switches the interrupt disable period to the interrupt enable period according to the interrupt end signal, and sets the interrupt mask record bit [0]~bit [3] to 1. Subsequently, the interrupt record bit [0]~bit [3] of the first interrupt request register unit 1111 are replaced with the interrupt record bit [0]~bit [3] of the second interrupt request register unit 1112, and the interrupt record bit [0]~bit [3] of the second interrupt request register unit 1112 are cleared to 0. Then, the interrupt control device 110 outputs the interrupt events to the system end 900 according to the interrupt record bit [0]~bit [3] of the first interrupt request register unit 1111 during the interrupt enable period. It should be noted that the detailed contents of the embodiments of FIG. 10 to FIG. 14 have been disclosed in the embodiments of FIG. 5 to FIG. 9, and thus the related description regarding FIG. 10 to FIG. 14 will be omitted herein for brevity.

It should be noted that the present disclosure is not limited to the embodiments as shown in FIG. 1 to FIG. 14, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The interrupt control device, the interrupt control method, and the network integrated circuit of the present disclosure are capable of recording additional interrupt events during the interrupt disable period and outputting the additional interrupt events during the interrupt enable period, thereby avoiding the problem that the additional interrupt events cannot be generated to notify the system end after the interrupt is disabled, resulting in the additional packets missing the opportunity to notify the system end for processing.

It should be noted that people having ordinary skill in the art can selectively use some or all of the features of any embodiment in this specification or selectively use some or all of the features of multiple embodiments in this specification to implement the present disclosure as long as such implementation is practicable; in other words, the way to implement the present disclosure can be flexible based on the present disclosure.

The descriptions represent merely the preferred embodiments of the present disclosure, without any intention to limit the scope of the present disclosure thereto. Various equivalent changes, alterations, or modifications based on the claims of the present disclosure are all consequently viewed as being embraced by the scope of the present disclosure.

What is claimed is:

1. An interrupt control device, comprising:
an interrupt request register, configured to record a first interrupt event during an interrupt enable period, wherein the interrupt control device outputs the first interrupt event during the interrupt enable period; and
an interrupt mask register, configured to switch the interrupt enable period to an interrupt disable period according to an interrupt acknowledge signal, wherein the interrupt request register records a second interrupt event during the interrupt disable period, wherein the interrupt mask register switches the interrupt disable period to the interrupt enable period according to an interrupt end signal, and the interrupt control device outputs the second interrupt event during the interrupt enable period.

2. The interrupt control device of claim 1, wherein the interrupt request register records the first interrupt event as a first interrupt record during the interrupt enable period, and the interrupt control device outputs the first interrupt event according to the first interrupt record during the interrupt enable period.

3. The interrupt control device of claim 2, wherein the interrupt mask register receives the interrupt acknowledge signal during the interrupt enable period, and switches the interrupt enable period to the interrupt disable period according to the interrupt acknowledge signal, wherein the interrupt request register records the second interrupt event as a second interrupt record during the interrupt disable period, wherein the interrupt mask register receives the interrupt end signal during the interrupt disable period, and switches the interrupt disable period to the interrupt enable period according to the interrupt end signal, wherein the interrupt control device outputs the second interrupt event according to the second interrupt record during the interrupt enable period.

4. The interrupt control device of claim 1, wherein the interrupt request register comprises:
a first interrupt request register unit, configured to record the first interrupt event as a first interrupt record during the interrupt enable period.

5. The interrupt control device of claim 4, further comprising:
an interrupt service register, configured to record an interrupt service record according to the first interrupt record during the interrupt enable period, wherein the interrupt control device outputs the first interrupt event according to the interrupt service record during the interrupt enable period.

6. The interrupt control device of claim 5, wherein the interrupt mask register receives the interrupt acknowledge signal during the interrupt enable period, and switches the interrupt enable period to the interrupt disable period according to the interrupt acknowledge signal, wherein the interrupt request register further comprises:
a second interrupt request register unit, configured to record the second interrupt event as a second interrupt record during the interrupt disable period.

7. The interrupt control device of claim 6, wherein the interrupt mask register receives the interrupt end signal during the interrupt disable period, switches the interrupt disable period to the interrupt enable period according to the interrupt end signal, and replaces the first interrupt record of the first interrupt request register unit with the second interrupt record of the second interrupt request register unit, wherein the interrupt control device outputs the second interrupt event according to the second interrupt record of the first interrupt request register unit during the interrupt enable period.

8. The interrupt control device of claim 7, wherein the first interrupt event comprises N first interrupt events, wherein N first bits of the first interrupt request register unit are configured to record the N first interrupt events as N first interrupt records, wherein N is a positive integer; and
wherein the interrupt control device outputs one of the N first interrupt events to one of N interrupt vectors of a system end according to one of the N first interrupt records during the interrupt enable period.

9. The interrupt control device of claim 8, wherein the second interrupt event comprises N second interrupt events, wherein N second bits of the second interrupt request register unit are configured to record the N second interrupt events as N second interrupt records; and
wherein the N first interrupt records of the N first bits are replaced with the N second interrupt records of the N second bits, wherein the interrupt control device outputs one of the N second interrupt events to one of the N interrupt vectors of the system end according to one of the N second interrupt records of the N first bits during the interrupt enable period.

10. The interrupt control device of claim 7, wherein the first interrupt event comprises N first interrupt events, wherein N first bits of the first interrupt request register unit are configured to record the N first interrupt events as N first interrupt records, wherein the N first interrupt records are divided into M groups of first interrupt records, wherein N and M are positive integers, and N is greater than M; and
wherein the interrupt control device outputs one of M first interrupt events to one of M interrupt vectors of a system end according to one of the M groups of first interrupt records during the interrupt enable period.

11. The interrupt control device of claim 10, wherein the second interrupt event comprises N second interrupt events, wherein N second bits of the second interrupt request register unit are configured to record the N second interrupt events as N second interrupt records, wherein the N second interrupt records are divided into M groups of second interrupt records; and
wherein the M groups of first interrupt records of the N first bits are replaced with the M groups of second interrupt records of the N second bits, and the interrupt control device outputs one of M second interrupt events to one of the M interrupt vectors of the system end according to one of the M groups of second interrupt records of the N first bits during the interrupt enable period.

12. An interrupt control method, applied in an interrupt control device, wherein the interrupt control device comprises an interrupt request register and an interrupt mask register, wherein the interrupt control method comprises:
recording a first interrupt event by the interrupt request register during an interrupt enable period, and outputting the first interrupt event by the interrupt control device during the interrupt enable period;
switching the interrupt enable period to an interrupt disable period by the interrupt mask register according to an interrupt acknowledge signal, and recording a second interrupt event by the interrupt request register during the interrupt disable period; and
switching the interrupt disable period to the interrupt enable period by the interrupt mask register according to an interrupt end signal, and outputting the second interrupt event by the interrupt control device during the interrupt enable period.

13. The interrupt control method of claim 12, wherein recording the first interrupt event by the interrupt request register during the interrupt enable period, and outputting the first interrupt event by the interrupt control device during the interrupt enable period comprises:
recording the first interrupt event as a first interrupt record by the interrupt request register during the interrupt enable period, and outputting the first interrupt event by the interrupt control device according to the first interrupt record during the interrupt enable period.

14. The interrupt control method of claim 13, wherein switching the interrupt enable period to the interrupt disable period by the interrupt mask register according to the interrupt acknowledge signal, and recording the second interrupt event by the interrupt request register during the interrupt disable period comprises:
receiving the interrupt acknowledge signal by the interrupt mask register during the interrupt enable period, and switching the interrupt enable period to the interrupt disable period according to the interrupt acknowledge signal, wherein the interrupt request register records the second interrupt event as a second interrupt record during the interrupt disable period; and
wherein switching the interrupt disable period to the interrupt enable period by the interrupt mask register according to the interrupt end signal, and outputting the second interrupt event by the interrupt control device during the interrupt enable period comprises:
receiving the interrupt end signal by the interrupt mask register during the interrupt disable period, and switching the interrupt disable period to the interrupt enable period according to the interrupt end signal, wherein the interrupt control device outputs the second interrupt event according to the second interrupt record during the interrupt enable period.

15. The interrupt control method of claim 12, wherein recording the first interrupt event by the interrupt request register during the interrupt enable period comprises:
recording the first interrupt event as a first interrupt record by a first interrupt request register unit of the interrupt request register during the interrupt enable period.

16. The interrupt control method of claim 15, wherein outputting the first interrupt event by the interrupt control device during the interrupt enable period comprises:
recording an interrupt service record by an interrupt service register of the interrupt control device according to the first interrupt record during the interrupt enable period; and
outputting the first interrupt event by the interrupt control device according to the interrupt service record during the interrupt enable period.

17. The interrupt control method of claim 16, wherein switching the interrupt enable period to the interrupt disable period by the interrupt mask register according to the interrupt acknowledge signal, and recording the second interrupt event by the interrupt request register during the interrupt disable period comprises:
receiving the interrupt acknowledge signal by the interrupt mask register during the interrupt enable period, and switching the interrupt enable period to the interrupt disable period according to the interrupt acknowledge signal, wherein a second interrupt request register unit of the interrupt request register records the second interrupt event as a second interrupt record during the interrupt disable period.

18. The interrupt control method of claim 17, wherein switching the interrupt disable period to the interrupt enable period by the interrupt mask register according to the interrupt end signal, and outputting the second interrupt event by the interrupt control device during the interrupt enable period comprises:
receiving the interrupt end signal by the interrupt mask register during the interrupt disable period, switching the interrupt disable period to the interrupt enable period according to the interrupt end signal, wherein the first interrupt record of the first interrupt request register unit is replaced with the second interrupt record of the second interrupt request register unit, and the interrupt control device outputs the second interrupt event according to the second interrupt record of the first interrupt request register unit during the interrupt enable period.

19. A network integrated circuit, comprising:
an interrupt control device, comprising:
an interrupt request register, configured to record a first interrupt event during an interrupt enable period, wherein the interrupt control device outputs the first interrupt event during the interrupt enable period; and
an interrupt mask register, configured to switch the interrupt enable period to an interrupt disable period according to an interrupt acknowledge signal, wherein the interrupt request register records a second interrupt event during the interrupt disable period, wherein the interrupt mask register switches the interrupt disable period to the interrupt enable period according to an interrupt end signal, and the interrupt control device outputs the second interrupt event during the interrupt enable period.

20. The network integrated circuit of claim 19, wherein the interrupt request register records the first interrupt event as a first interrupt record during the interrupt enable period, and the interrupt control device outputs the first interrupt event according to the first interrupt record during the interrupt enable period; and
wherein the interrupt mask register receives the interrupt acknowledge signal during the interrupt enable period, and switches the interrupt enable period to the interrupt disable period according to the interrupt acknowledge signal, wherein the interrupt request register records the second interrupt event as a second interrupt record during the interrupt disable period, wherein the interrupt mask register receives the interrupt end signal during the interrupt disable period, and switches the interrupt disable period to the interrupt enable period according to the interrupt end signal, wherein the interrupt control device outputs the second interrupt event according to the second interrupt record during the interrupt enable period.
